(19) United States
(12) Patent Application Publication
(10) Pub. No.: US 2025/0116842 A1
(43) Pub. Date: Apr. 10, 2025

(54) OPTICAL ELEMENT DRIVING MECHANISM

(71) Applicant: TDK TAIWAN CORP., Taoyuan City (TW)

(72) Inventors: Wei-Jhe SHEN, Taoyuan City (TW); Sin-Jhong SONG, Taoyuan City (TW)

(21) Appl. No.: 18/907,118

(22) Filed: Oct. 4, 2024

Related U.S. Application Data
(60) Provisional application No. 63/588,441, filed on Oct. 6, 2023.

(51) Int. Cl. G02B 7/08; G02B 7/18; G02B 27/64

(52) U.S. Cl. CPC G02B 7/08; G02B 7/1805; G02B 27/646

(57) ABSTRACT

An optical element driving mechanism includes a fixed assembly, a first optical module and a driving assembly. The first optical module includes a first movable part configured to be connected to a first optical element, and the first movable part is movable relative to the fixed assembly. The driving assembly is configured to drive the first movable part to move relative to the fixed assembly.

### CROSS REFERENCE TO RELATED APPLICATIONS

This application claims the benefit of U.S. Provisional Application No. 63/588,441, filed on Oct. 6, 2023, the entirety of which is incorporated by reference herein.

### BACKGROUND OF THE INVENTION

### Field of the Disclosure

The present disclosure relates to an optical element driving mechanism, and in particular to a miniaturized optical element driving mechanism with a long focal length.

### Description of the Related Art

As technology has developed, many of today's electronic devices (such as smartphones) have been equipped with cameras to provide photographic and video functionality. Users can capture photographs and record videos using the camera modules disposed in their electronic devices.

Today's design of electronic devices continues to follow the trend towards miniaturization, meaning that the structure of a camera module, as well as its various components, must also be continuously reduced in size. In general, the driving mechanism of a camera module has a camera lens holder configured to hold a camera lens, and the driving mechanism can have the functions of auto focusing and optical image stabilization. Although existing driving mechanisms can achieve the aforementioned functions of taking photographs and recording videos, however, they still cannot meet all users' needs.

Therefore, how to design a camera module that can perform autofocus, optical anti-shake and achieve miniaturization at the same time is topic nowadays that needs to be discussed and solved.

### BRIEF SUMMARY OF THE INVENTION

Accordingly, one objective of the present disclosure is to provide an optical element driving mechanism to solve the above problems.

According to some embodiments of the disclosure, an optical element driving mechanism includes a fixed assembly, a first optical module and a driving assembly. The first optical module includes a first movable part configured to be connected to a first optical element, and the first movable part is movable relative to the fixed assembly. The driving assembly is configured to drive the first movable part to move relative to the fixed assembly.

According to some embodiments, the fixed assembly includes a casing and a supporting base. The casing and the supporting base are arranged along a main axis. The casing is fixedly connected to the supporting base. The supporting base is configured to carry a second optical element and a third optical element. The casing has a casing opening, and an external light is emitted from a light incident end into the casing opening. The external light enters the second optical element through the casing opening, and then passes through the third optical element to be received by the first optical element. The optical element driving mechanism further includes a first circuit assembly which is connected to the first movable part and the supporting base. The first optical element is electrically connected to the first circuit assembly. The first circuit assembly has a movable end portion which is connected to the first movable part. The movable end portion is closer to the casing than the supporting base. The movable end portion is closer to the light incident end than the third optical element. When viewed along a first axis, the movable end portion overlaps at least a portion of the second optical element. The first axis is perpendicular to the main axis.

The present disclosure provides an optical element driving mechanism, which includes a fixed assembly, a first optical module, a second optical module and a driving assembly. The first optical module is configured to be connected to a first optical element, and the driving assembly is configured to drive multiple movable parts in the first optical module to drive the first optical element to move, so as to achieve the purpose of autofocus and optical anti-shake.

Furthermore, the supporting base of the fixed assembly is configured to carry the second optical element and the third optical element. It is worth mentioning that the first optical element, the second optical element and the third optical element are not arranged along a straight line. When viewed along the main axis, the third optical element overlaps a portion of the first optical element and also overlaps a portion of the second optical element. When viewed along the first axis, the first optical element overlaps a portion of the second optical element.

Based on such a configuration, the overall height of the optical element driving mechanism can be effectively reduced. In addition, the base of the first optical module may have a first groove which may accommodate a portion of the supporting base and the third optical element. That is, when the first optical module is disposed on the supporting base, the overall height of the optical element driving mechanism can be further reduced to further achieve the purpose of miniaturization.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an optical element driving mechanism 10 according to an embodiment of the present disclosure.

FIG. 2 is an exploded diagram of the optical element driving mechanism 10 according to an embodiment of the present disclosure.

FIG. 3 is a cross-sectional view of the optical element driving mechanism 10 along line A-A in FIG. 1 according to an embodiment of the present disclosure.

FIG. 4 is an exploded diagram of the first optical module 100 according to an embodiment of the present disclosure.

FIG. 5 is a bottom view of a partial structure of the optical element driving mechanism 10 according to an embodiment of the present disclosure.

FIG. 6 is a perspective view of the first optical module 100 in another view according to an embodiment of the present disclosure.

FIG. 7 is a cross-sectional view of the first optical module 100 along line B-B in FIG. 6 according to an embodiment of the present disclosure.

FIG. 8 is a cross-sectional view of the first optical module 100 along the line C-C in FIG. 6 according to an embodiment of the present disclosure.

FIG. 9 is a bottom view of a partial structure of the first optical module 100 according to an embodiment of the present disclosure.

FIG. 10 is a perspective view of the first optical module 100 in another view according to an embodiment of the present disclosure.

FIG. 11 is a front view of the first optical module 100 upside down according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

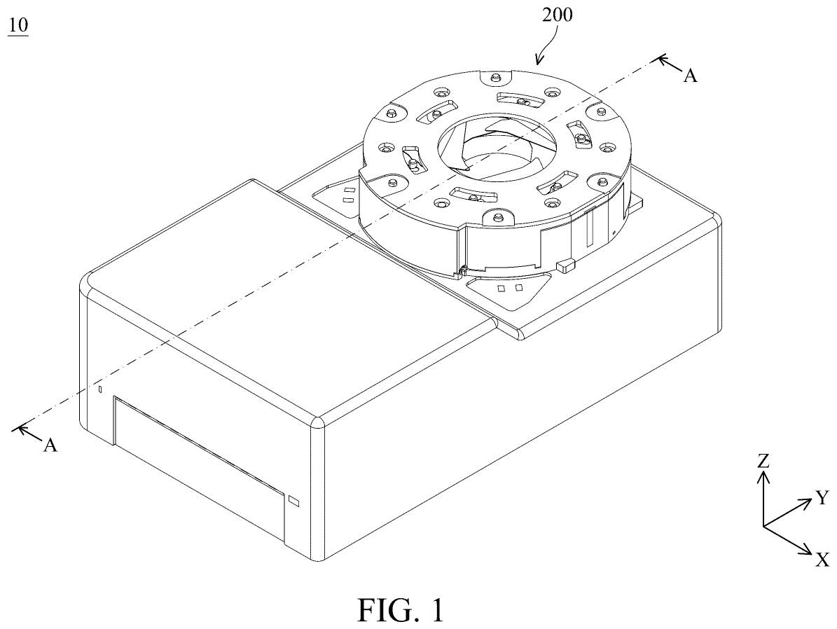

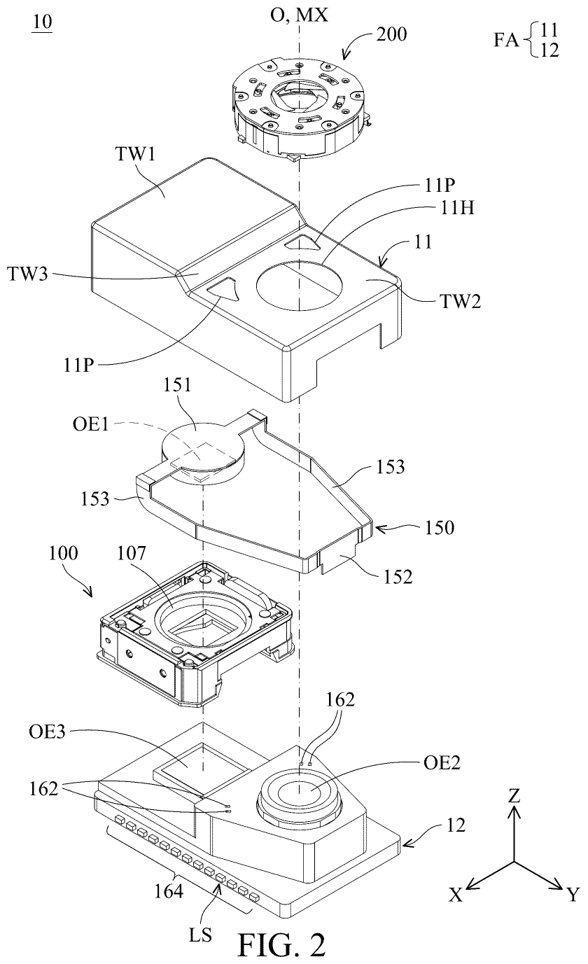

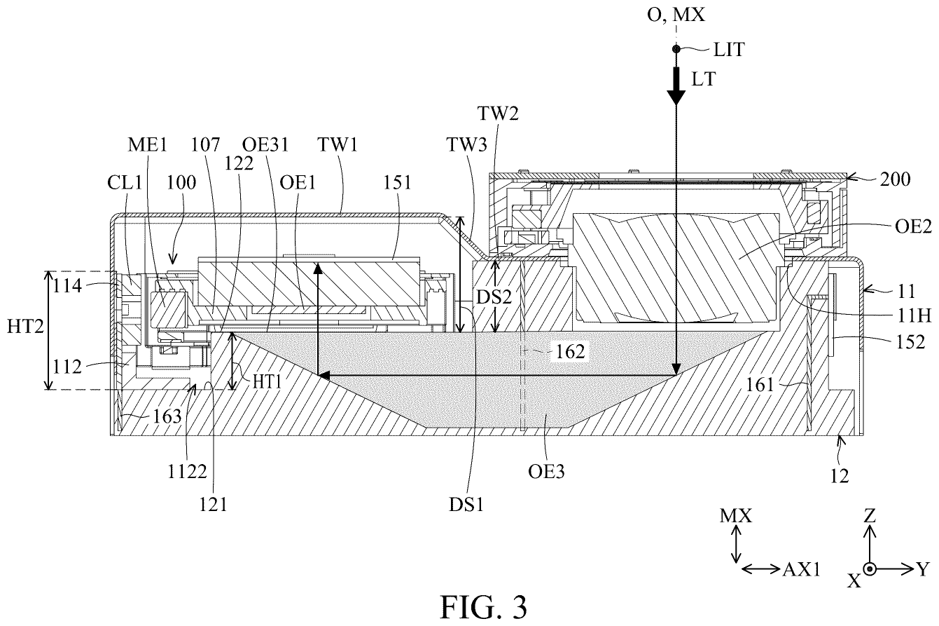

Please refer to FIG. 1 to FIG. 3. FIG. 1 is a schematic diagram of an optical element driving mechanism 10 according to an embodiment of the present disclosure, FIG. 2 is an exploded diagram of the optical element driving mechanism 10 according to an embodiment of the present disclosure, and FIG. 3 is a cross-sectional view of the optical element driving mechanism 10 along line A-A in FIG. 1 according to an embodiment of the present disclosure. The optical element driving mechanism 10 can be an optical camera module and can be configured to hold and drive at least one optical element. The optical element driving mechanism 10 can be installed in various electronic devices or portable electronic devices, such as a smartphone, for allowing a user to perform the image capturing function. In this embodiment, the optical element driving mechanism 10 may be a voice coil motor (VCM) with an autofocus (AF) function, but it is not limited thereto. In other embodiments, the optical element driving mechanism 10 can also perform the functions of auto-focusing and optical image stabilization (OIS).

In this embodiment, the optical element driving mechanism 10 may include a fixed assembly FA, a first optical module 100, a second optical module 200 and a first circuit assembly 150. The fixed assembly FA includes a casing 11 and a supporting base 12, and the casing 11 and the supporting base 12 are arranged along a main axis MX. Specifically, the casing 11 is fixedly connected to the supporting base 12.

As shown in FIG. 2, the first optical module 100 may include a first movable part 107 configured to be connected to a first optical element OE1, and the first movable part 107 is movable relative to the fixed assembly FA. The first optical element OE1 is, for example, an image sensor, but it is not limited thereto.

In this embodiment, the first circuit assembly 150 may be a flexible circuit board which is connected to the first movable part 107 and the supporting base 12. The first circuit assembly 150 may have a movable end portion 151 which is connected to the first movable part 107, and the first optical element OE1 is electrically connected to the first circuit assembly 150. Specifically, the first optical element OE1 is disposed at the bottom of the movable end portion 151.

Furthermore, the first circuit assembly 150 may have a fixed end portion 152 and two cantilevers 153. The fixed end portion 152 is affixed to the supporting base 12, and the two cantilevers 153 are connected between the movable end portion 151 and the fixed end portion 152. When the first movable part 107 moves, the movable end portion 151 and the first optical element OE1 can move relative to the fixed end portion 152 along with the first movable part 107.

As shown in FIG. 2 and FIG. 3, the supporting base 12 is configured to carry a second optical element OE2 and a third optical element OE3. The second optical element OE2 is, for example, a fixed camera lens, and the third element OE3 is, for example, a prism, but they are not limited thereto.

As shown in FIG. 2 and FIG. 3, the casing 11 may have a casing opening 11H, and an external light LT is emitted from a light incident end LIT along an optical axis O into the casing opening 11H. The optical axis O is, for example, parallel to or overlapping the main axis MX, but it is not limited thereto. After the external light LT enters the second optical element OE2 through the casing opening 11H, it will then be reflected by the third optical element OE3, and finally received by the first optical element OE1, so as to generate a digital image signal.

In addition, in this embodiment, the casing 11 can be made of non-magnetic material, such as plastic material, but it is not limited thereto. As shown in FIG. 3, the casing 11 covers the first optical element OE1 and at least a portion of the second optical element OE2.

The casing 11 may have a first top wall TW1 and a second top wall TW2, and the second optical module 200 is disposed on the second top wall TW2 and surrounds a portion of the second optical element OE2.

The second optical module 200 is, for example, an aperture module that can adjust the amount of light of the external light LT, but it is not limited thereto. In addition, the second top wall TW2 is formed with the aforementioned casing opening 11H, and a portion of the second optical element OE2 is disposed in the casing opening 11H.

Furthermore, as shown in FIG. 3, the casing 11 can further have an inclined wall TW3. The inclined wall TW3 is connected between the first top wall TW1 and the second top wall TW2, and the angle between the inclined wall TW3 and the second top wall TW2 is between 30 and 60 degrees, but it is not limited thereto. The inclined wall TW3, the first top wall TW1 and the second top wall TW2 can be integrally formed as one piece.

As shown in FIG. 3, when viewed along the main axis MX, the first optical element OE1 overlaps the first top wall TW1, and when viewed along the main axis MX, the first top wall TW1 completely shields the first optical element OE1.

As shown in FIG. 3, the supporting base 12 has a first supporting surface 121 and a second supporting surface 122. The base 112 is disposed on the first supporting surface 121, and the second optical module 200 is disposed on the second supporting surface 122. Along the main axis MX, there is a first distance DS1 between the first top wall TW1 and the second supporting surface 122, and along the main axis MX, there is a second distance DS2 between the second top wall TW2 and the second supporting surface 122, and the first distance DS1 is greater than the second distance DS2.

In addition, as shown in FIG. 3, the movable end portion 151 is closer to the casing 11 than the supporting base 12, that is, closer to the first top wall TW1, and the movable end portion 151 is closer to the light incident end LIT than the third optical element OE3 (in the direction of main axis MX). When viewed along a first axis AX1, the movable end portion 151 overlaps at least a portion of the second optical element OE2, and the first axis AX1 is perpendicular to the main axis MX.

Based on the above structural design and element configuration, the overall height of the optical element driving mechanism 10 along the main axis MX (on the Z-axis) can be reduced so as to achieve the purpose of miniaturization.

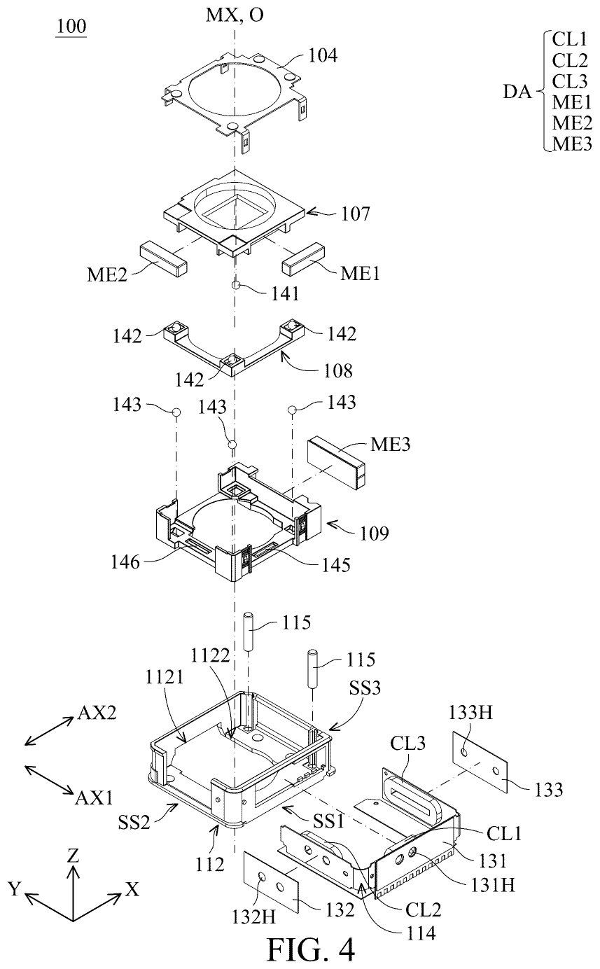

Next, please refer to FIG. 3 and FIG. 4. FIG. 4 is an exploded diagram of the first optical module 100 according to an embodiment of the present disclosure. In this embodiment, the first optical module 100 further includes a frame 104, a base 112, a second movable part 108 and a third movable part 109. The frame 104 is affixed to the base 112 and cooperatively accommodates the aforementioned plurality of movable parts. The aforementioned fixed assembly FA may further include the frame 104 and the base 112.

Furthermore, the first optical module 100 of the optical element driving mechanism 10 further includes a driving assembly DA configured to drive the first movable part 107 to move relative to the fixed assembly FA. Specifically, the driving assembly DA is configured to drive the first movable part 107 to move along a second axis AX2 relative to the second movable part 108 and the third movable part 109. The second axis AX2 is perpendicular to the first axis AX1 and the main axis MX.

In this embodiment, the driving assembly DA may include a second coil CL2 and a second magnetic element ME2 configured to generate a second electromagnetic driving force to drive the first movable part 107 to move along the second axis AX2.

On the other hand, the driving assembly DA can be configured to drive the second movable part 108 and the first movable part 107 to move along the first axis AX1 relative to the third movable part 109. Specifically, the driving assembly DA may further include a first coil CL1 and a first magnetic element ME11 configured to generate a first electromagnetic driving force to drive the second movable part 108 and the first movable part 107 to move along the first axis AX1.

Furthermore, the driving assembly DA can be configured to drive the third movable part 109 to drive the first movable part 107 and the second movable part 108 to move along the main axis MX. Specifically, the driving assembly DA further includes a third coil CL3 and a third magnetic element ME3 configured to generate a third electromagnetic driving force to drive the third movable part 109, the second movable part 108 and the first movable part 107 to move along main axis MX.

As shown in FIG. 4, the first optical module 100 may further include two guiding members 115, which are fixedly disposed on the base 112 and configured to guide the third movable part 109 to move along the main axis MX. Each of the guiding members 115 is, for example, a metal cylinder, but they are not limited thereto.

In this embodiment, the first optical module 100 may further include a second circuit assembly 114 which is disposed on the base 112, and the aforementioned first coil CL1, the second coil CL2 and the third coil CL3 are disposed on the second circuit assembly 114. The second circuit assembly 114 is, for example, a flexible circuit board, but it is not limited thereto.

Correspondingly, the first magnetic element ME1 and the second magnetic element ME2 are disposed on the first movable part 107, and the third magnetic element ME3 is disposed on the third movable part 109. The first magnetic element ME1, the second magnetic element ME2 and the third magnetic element ME3 are, for example, magnets, but they are not limited thereto.

Next, as shown in FIG. 3 and FIG. 4, the base 112 may have a first opening 1121, corresponding to the external light LT passing through the third optical element OE3. The base 112 may further have a first groove 1122 which is communicated with the first opening 1121, and a portion of the supporting base 12 and the third optical element OE3 may be located in the first groove 1122.

As shown in FIG. 3, the second supporting surface 122 corresponds to a light-emitting surface OE31 of the third optical element OE3. For example, the light-emitting surface OE31 is substantially aligned with the second supporting surface 122, but it is not limited thereto.

As shown in FIG. 3, when viewed along the second axis AX2 (the X-axis), there is a first height HT1 between the first supporting surface 121 and the second supporting surface 122 along the main axis MX, and when viewed along the second axis AX2, the first optical module 100 has a second height HT2.

In this embodiment, the first height HT1 is greater than the second height HT2. For example, the first height HT1 is greater than one third of the second height HT2. In addition, as shown in FIG. 3, when viewed along the first axis AX1, the first coil CL1 overlaps at least a portion of the second optical element OE2.

That is, when the first optical module 100 is disposed on the supporting base 12, based on the above structural design, the overall height of the optical element driving mechanism 10 can be reduced to further achieve the purpose of miniaturization.

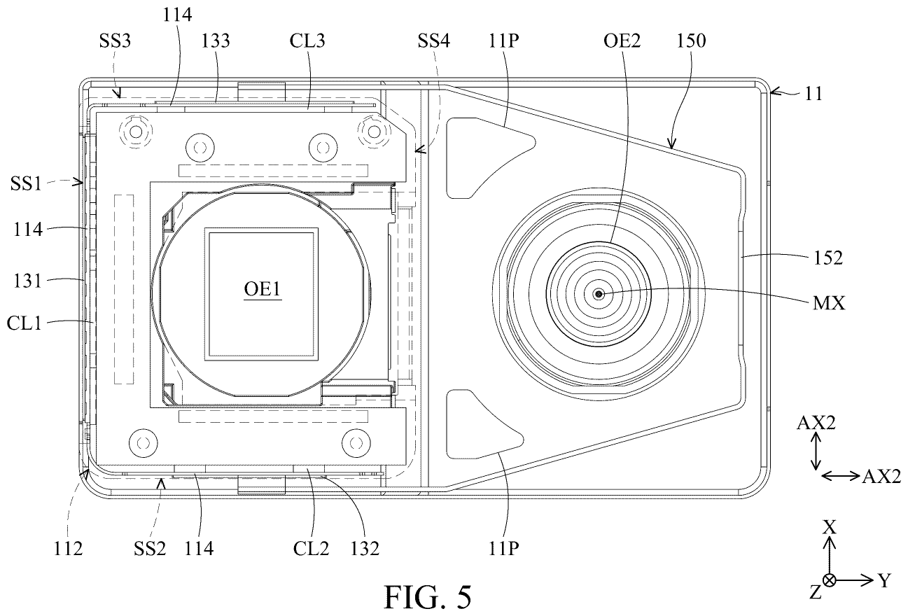

Next, please refer to FIG. 3 to FIG. 5. FIG. 5 is a bottom view of a partial structure of the optical element driving mechanism 10 according to an embodiment of the present disclosure. As shown in FIG. 5, when viewed along the main axis MX, the base 112 substantially has a rectangular structure, and the first coil CL1, the second coil CL2 and the third coil CL3 are respectively located on a first side SS1, a second side SS2 and a third side SS3 of the rectangular structure. It should be noted that, in order to clearly show the internal structure of the first optical module 100, the base 112 in FIG. 5 is illustrated with a dotted line, but this does not mean that the base 112 does not exist, and the other components shown with a dotted line in subsequent figures are the same.

As shown in FIG. 5, the second optical element OE2 is located on a fourth side SS4 of the rectangular structure. That is, the second optical element OE2 is located on the right side of the base 112 in FIG. 5. The first side SS1 and the fourth side SS4 are opposite sides of the rectangular structure, and the second side SS2 and the third side SS3 are opposite sides of the rectangular structure.

It is worth noting that the third coil CL3 used to drive the third movable part 109 is not arranged on the first side SS1 so as to ensure that the arrangement of the first coil CL1 and the second coil CL2 can drive the first movable part 107 to move along first axis AX1 and/or the second axis AX2.

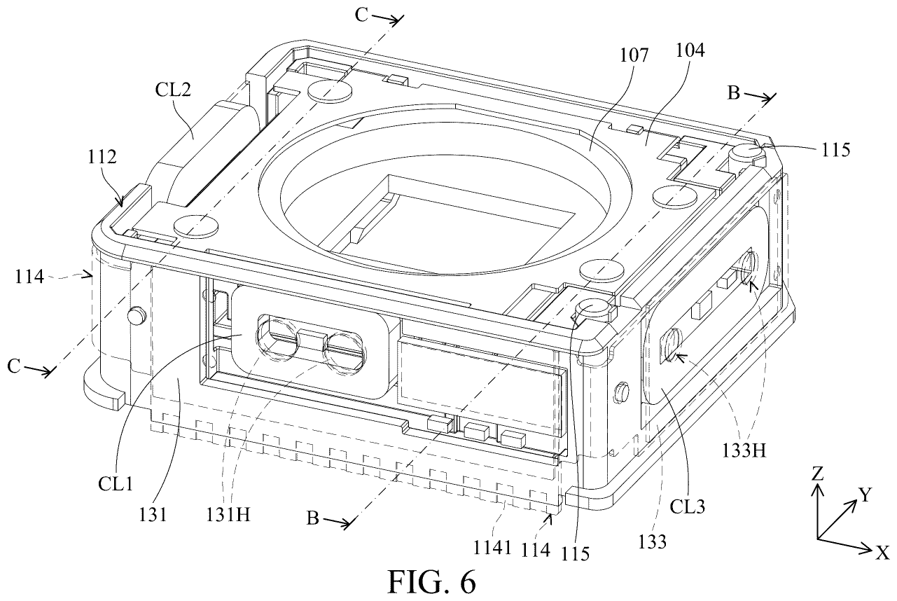

Furthermore, please refer to FIG. 4 to FIG. 6. FIG. 6 is a perspective view of the first optical module 100 in another view according to an embodiment of the present disclosure. As shown in FIG. 4 to FIG. 6, the second circuit assembly 114 is bent to be disposed on the base 112 and is located on the first side SS1, the second side SS2 and the third side SS3.

In order to increase the overall structural strength of the second circuit assembly 114, the first optical module 100 may further include a first supporting member 131, a second supporting member 132 and a third supporting member 133, which are fixedly disposed on the second circuit assembly 114 and respectively corresponds to the first coil CL1, the second coil CL2 and the third coil CL3.

It is worth noting that the third supporting member 133 is made of magnetically permeable metal material. Therefore, the third supporting member 133 and the third magnetic element ME3 can generate a magnetic attraction force to drive the third movable part 109 toward the guiding members 115, thereby ensuring that the third movable part 109 does not tilt when moving along the main axis MX.

In addition, the first supporting member 131 and the second supporting member 132 are made of non-magnetically permeable metal material to avoid interfering the first magnetic element ME1 and the second magnetic element ME2, thereby ensuring that the first movable part 107 can smoothly move along the first axis AX1 or the second axis AX2.

Next, as shown in FIG. 4 and FIG. 6, the first optical module 100 further has two first perforations 131H, penetrate the first supporting member 131 and the second circuit assembly 114, and these two first perforations 131H corresponds to the first coil CL1.

Similarly, the first optical module 100 may further have two second perforations 132H, penetrate the second supporting member 132 and the second circuit assembly 114, and the two second perforations 132H correspond to the second coil CL2.

Furthermore, the first optical module 100 may further have two third perforations 133H, penetrate the third supporting member 133 and the second circuit assembly 114, and these two third perforations 133H correspond to the third coil CL3.

Based on the configuration of the above-mentioned perforations, it is easier to use a tool to install the first coil CL1, the second coil CL2 and the third coil CL3 on the second circuit assembly 114 by passing through these perforations, and the accuracy of positioning can also be increased.

Then return to FIG. 2, FIG. 3 and FIG. 6. As shown in FIG. 3, the optical element driving mechanism 10 further includes at least one first electrical member 161, at least one second electrical member 162 and at least one third electrical member 163, which are partially disposed in the supporting base 12. For example, the first electrical member 161, the second electrical member 162 and the third electrical member 163 are disposed in the supporting base 12 by insert molding technology.

It should be noted that the number of the first electrical member 161, the second electrical member 162 and the third electrical member 163 is not limited to the number in FIG. 3. Furthermore, as shown in FIG. 2, the optical element driving mechanism 10 further includes a plurality of electrical pins 164 (pins) which are partially disposed in the supporting base 12, and these electrical pins 164 are electrically connected to the aforementioned electrical members.

As shown in FIG. 3, the fixed end portion 152 is electrically connected to at least one first electrical member 161, so that the first optical element OE1 can be electrically connected to the at least one first electrical member 161 through the first circuit assembly 150.

Furthermore, as shown in FIG. 2, the second top wall TW2 of the casing 11 is further formed with two side openings 11P which are arranged on one side of the casing opening 11H, and the plurality of second electrical members 162 are exposed from the two side openings 11P. Therefore, as shown in FIG. 3, the second optical module 200 can be electrically connected to the second electrical members 162 through the two side openings 11P, for example, by welding.

Next, as shown in FIG. 3 and FIG. 6, the second circuit assembly 114 has a plurality of electrical contacts 1141 configured to be electrically connected to a plurality of third electrical members 163, so that the plurality of coils of the driving assembly DA are electrically connected to these third electrical members 163.

The first electrical members 161, the second electrical members 162 and the third electrical members 163 can be electrically connected to an external circuit through the electrical pins 164. The external circuit is, for example, a control circuit on the motherboard of the portable electronic device, which can send control signals to control the actions of the first optical module 100, the second optical module 200, and the first optical element OE1.

It is worth noting that, as shown in FIG. 2, when viewed along the main axis MX, the supporting base 12 may have a rectangular structure, and these electrical pins 164 are located on a long side LS of the rectangular structure. Based on this design, the convenience and space utilization of the optical element driving mechanism 10 which is installed on the motherboard of the portable electronic device can be increased.

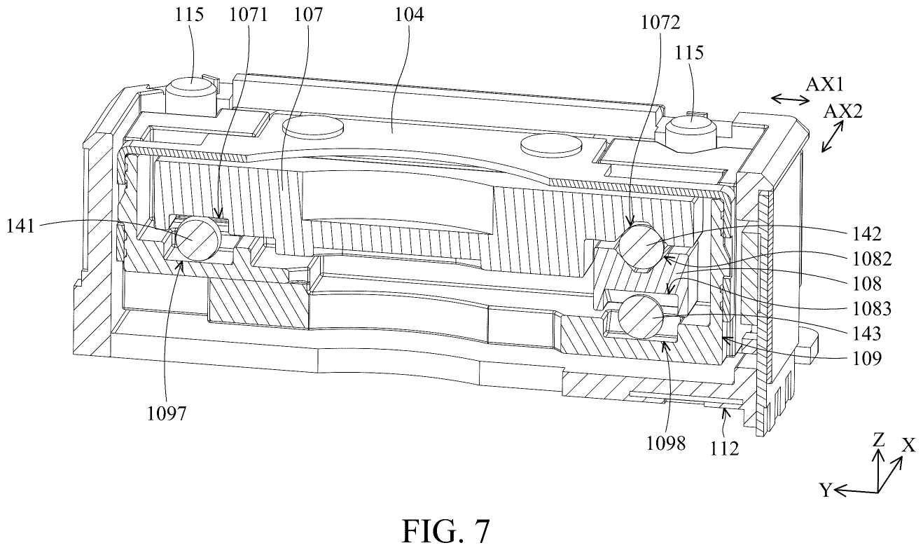

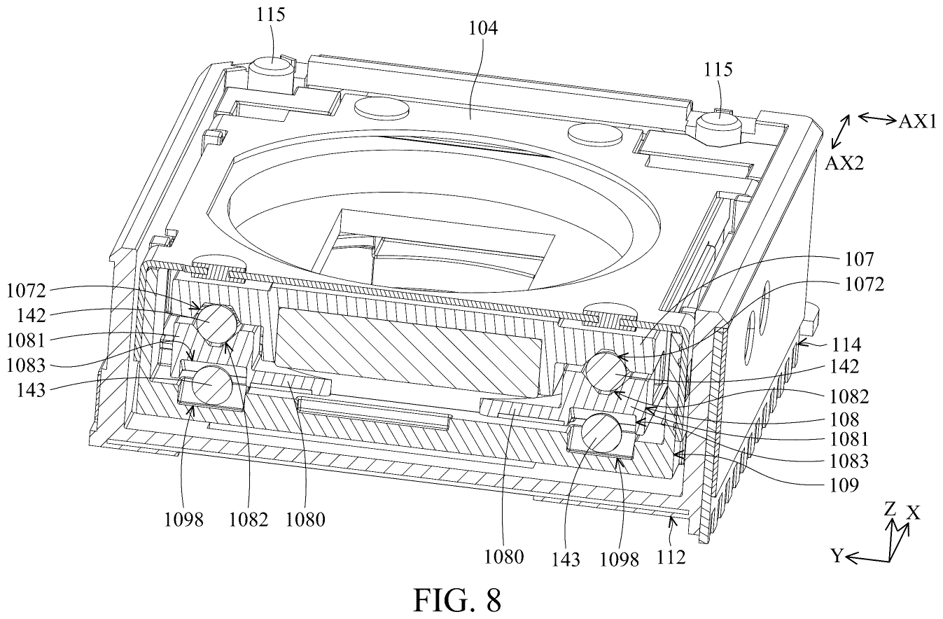

Please continue to refer to FIG. 4, FIG. 7 and FIG. 8. FIG. 7 is a cross-sectional view of the first optical module 100 along line B-B in FIG. 6 according to an embodiment of the present disclosure, and FIG. 8 is a cross-sectional view of the first optical module 100 along the line C-C in FIG. 6 according to an embodiment of the present disclosure. In this embodiment, as shown in FIG. 4 and FIG. 7, the first optical module 100 may further include a first rolling element 141 which is disposed between the first movable part 107 and the third movable part 109.

Similarly, as shown in FIG. 4 and FIG. 8, the first optical module 100 may further include a plurality of second rolling elements 142 which are disposed between the first movable part 107 and the second movable part 108, and the first optical module 100 may further include a plurality of third rolling elements 143 which are disposed between the second movable part 108 and the third movable part 109. In this embodiment, the first optical module 100 may include three second rolling elements 142 and three third rolling elements 143, but their number is not limited to this embodiment.

As shown in FIG. 8, the second movable part 108 has a base plate 1080 and two protruding portions 1081, and the protruding portions 1081 are protruded from the base plate 1080 toward the first movable part 107. When viewed along the first axis AX1, the protruding portions 1081 overlap at least a portion of the first movable part 107.

Based on such a structural configuration, the overall height of the first optical module 100 on the Z-axis can be effectively reduced so as to achieve the purpose of miniaturization.

Furthermore, as shown in FIG. 7 and FIG. 8, the first movable part 107 has a first accommodation groove 1071 and three first slots 1072. The first accommodation groove 1071 is configured to accommodate the first rolling element 141, and these first slots 1072 are configured to accommodate the second rolling elements 142.

Correspondingly, the second movable part 108 has three second slots 1082 configured to accommodate these second rolling elements 142. The extending direction of the second slots 1082 is the same as the extending direction of the first slots 1072, such as extending along the second axis AX2.

Furthermore, the second movable part 108 further has three third slots 1083 configured to accommodate these third rolling elements 143, and as shown in FIG. 4, when viewed along the main axis MX, the second movable part 108 has an L-shaped structure.

Correspondingly, the third movable part 109 may have a second accommodation groove 1097 and three fourth slots 1098. The second accommodation groove 1097 is configured to accommodate the first rolling element 141, and these fourth slots 1098 are configured to accommodate these third rolling elements 143.

The extending direction of the fourth slots 1098 is the same as the extending direction of the third slots 1083, such as extending along the first axis AX1. It is worth noting that the first accommodation groove 1071 and the second accommodation groove 1097 each is, for example, a square groove, and their sizes are larger than the first rolling element 141, so that the first rolling element 141 can roll arbitrarily on the XY plane.

In addition, there may be a gap between the first rolling element 141 and the first movable part 107 to prevent the first movable part 107 from not moving smoothly relative to the third movable part 109 due to manufacturing process tolerances.

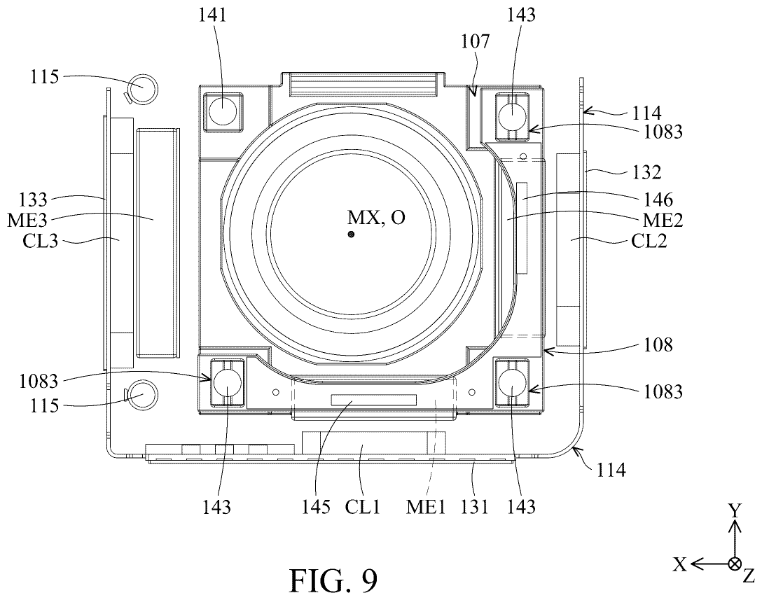

Next, please refer to FIG. 4 and FIG. 9. FIG. 9 is a bottom view of a partial structure of the first optical module 100 according to an embodiment of the present disclosure. In this embodiment, the first optical module 100 may further include a first magnetic conductive element 145 and a second magnetic conductive element 146 which are disposed on the third movable part 109.

The first magnetic conductive element 145 and the second magnetic conductive element 146 respectively correspond to the first magnetic element ME1 and the second magnetic element ME2. As shown in FIG. 9, when viewed along the main axis MX, the first magnetic conductive element 145 overlaps the first magnetic element ME11, and when viewed along the main axis MX, the second magnetic conductive element 146 overlaps the second magnetic element ME2.

Based on this configuration, a magnetic attraction force is generated between the first magnetic conductive element 145 and the first magnetic element ME11, and another magnetic attraction force is generated between the second magnetic conductive element 146 and the second magnetic element ME2, so that the first movable part 107 moves toward the third movable part 109 to clamp the second movable part 108, thereby ensuring that the first movable part 107 and the second movable part 108 can move smoothly relative to the third movable part 109.

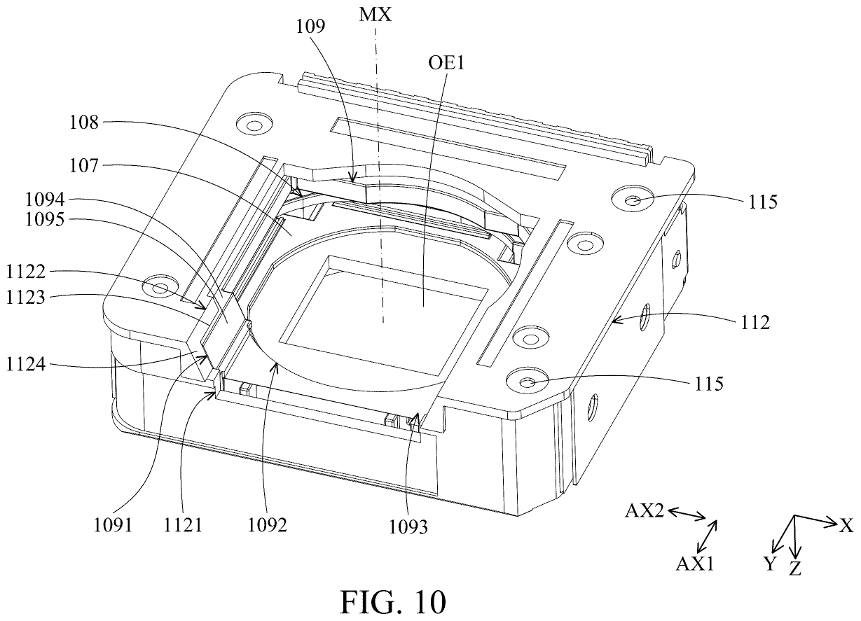

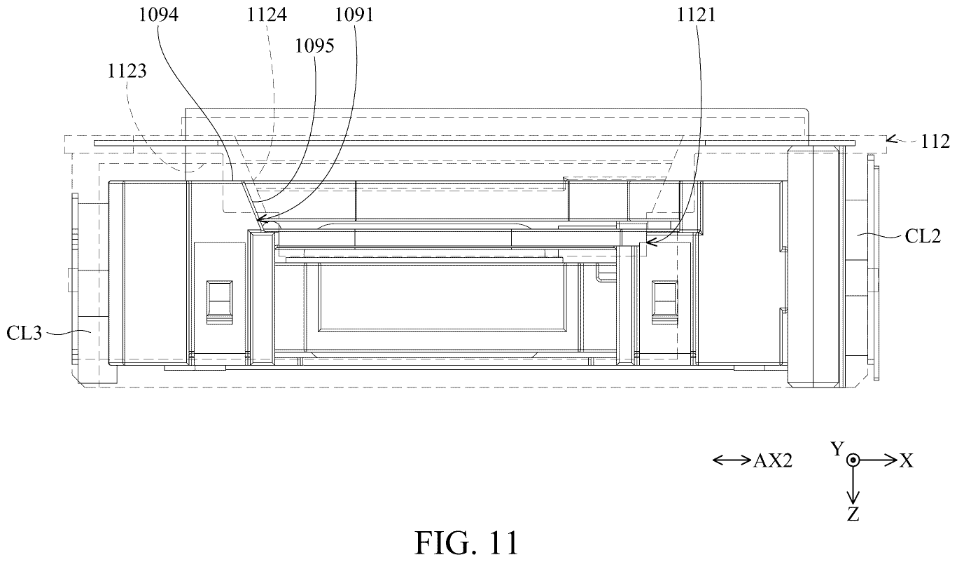

Next, please refer to FIG. 10 and FIG. 11. FIG. 10 is a perspective view of the first optical module 100 in another view according to an embodiment of the present disclosure, and FIG. 11 is a front view of the first optical module 100 upside down according to an embodiment of the present disclosure. As shown in FIG. 10, when viewed along the main axis MX, at least a portion of the third movable part 109, the first movable part 107 and the first optical element OE1 are exposed from the first groove 1122.

Furthermore, when viewed along the main axis MX, the second movable part 108 is shielded by the base 112. (It should be noted that although the second movable part 108 can be seen in the view of FIG. 10, the second movable part 108 is actually inside the third movable part 109, so that when viewed along the main axis MX, the second movable part 108 is shielded).

Similar to the structural design of the base 112, the third movable part 109 may have a second opening 1091, a third opening 1092 and a second groove 1093. The second opening 1091 is communicated with the first opening 1121 and the second groove 1093, and the first opening 1121 and the second opening 1091 face the third optical element OE3.

The second groove 1093 is located in the first groove 1122, and the first groove 1122 and the second groove 1093 are recessed toward the first optical element OE1, so that the second groove 1093 and the first groove 1122 can cooperatively accommodate a portion of the third optical element OE3.

The third opening 1092 is located in the second groove 1093 and is communicated with the second groove 1093, and when viewed along the main axis MX, the size of the first groove 1122 is greater than the size of the second groove 1093. Furthermore, the size of the first groove 1122 is greater than the size of the third opening 1092 when viewed along the main axis MX. Based on the above configuration, at least a portion of the first movable part 107 and at least a portion of the first optical element OE1 are exposed from the second groove 1093.

It is worth noting that, as shown in FIG. 10 and FIG. 11, the base 112 further has a first bottom surface 1123 and a first side inclined surface 1124, and the first side inclined surface 1124 obliquely extends from the first bottom surface 1123.

Similarly, the third movable part 109 has a second bottom surface 1094 and a second side inclined surface 1095, and the second side inclined surface 1095 obliquely extends from the second bottom surface 1094.

In this embodiment, the first bottom surface 1123 corresponds to the second bottom surface 1094, and a gap is formed between the first bottom surface 1123 and the second bottom surface 1094, so that the third movable part 109 has enough space to move along the main axis MX.

The first side inclined surface 1124 corresponds to the second side inclined surface 1095, and as shown in FIG. 11, the second side inclined surface 1095 is not aligned with the first side inclined surface 1124. That is, when viewed along the first axis AX1, the second side inclined surface 1095 does not overlap the first side inclined surface 1124, and the second side inclined surface 1095 is shielded by the base 112.

Furthermore, as shown in FIG. 10, when viewed along the main axis MX, a portion of the second bottom surface 1094 is exposed from the first groove 1122. Based on the above structural design of the first bottom surface 1123, the second bottom surface 1094, the first side inclined surface 1124 and the second side inclined surface 1095, unnecessary stray light can be blocked from entering the first optical element OE1 so as to ensure that the quality of digital images produced by the first optical element OE1.

The present disclosure provides an optical element driving mechanism 10, which includes a fixed assembly FA, a first optical module 100, a second optical module 200 and a driving assembly DA. The first optical module 100 is configured to be connected to a first optical element OE1, and the driving assembly DA is configured to drive multiple movable parts in the first optical module 100 to drive the first optical element OE1 to move, so as to achieve the purpose of autofocus and optical anti-shake.

Furthermore, the supporting base 12 of the fixed assembly FA is configured to carry the second optical element OE2 and the third optical element OE3. It is worth mentioning that the first optical element OE1, the second optical element OE2 and the third optical element OE3 are not arranged along a straight line. When viewed along the main axis MX, the third optical element OE3 overlaps a portion of the first optical element OE1 and also overlaps a portion of the second optical element OE2. When viewed along the first axis AX1, the first optical element OE1 overlaps a portion of the second optical element OE2.

Based on such a configuration, the overall height of the optical element driving mechanism 10 can be effectively reduced. In addition, the base 112 of the first optical module 100 may have a first groove 1122 which may accommodate a portion of the supporting base 12 and the third optical element OE3. That is, when the first optical module 100 is disposed on the supporting base 12, the overall height of the optical element driving mechanism 10 can be further reduced to further achieve the purpose of miniaturization.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical element driving mechanism, comprising:
a fixed assembly;
a first optical module, including a first movable part, configured to be connected to a first optical element, wherein the first movable part is movable relative to the fixed assembly; and
a driving assembly, configured to drive the first movable part to move relative to the fixed assembly.

2. The optical element driving mechanism as claimed in claim 1, wherein
the fixed assembly includes a casing and a supporting base;
the casing and the supporting base are arranged along a main axis;
the casing is fixedly connected to the supporting base;
the supporting base is configured to carry a second optical element and a third optical element;
the casing has a casing opening, and an external light is emitted from a light incident end into the casing opening; and
the external light enters the second optical element through the casing opening, and then passes through the third optical element to be received by the first optical element.

3. The optical element driving mechanism as claimed in claim 2, wherein
the optical element driving mechanism further includes a first circuit assembly which is connected to the first movable part and the supporting base;
the first optical element is electrically connected to the first circuit assembly;
the first circuit assembly has a movable end portion which is connected to the first movable part;
the movable end portion is closer to the casing than the supporting base;
the movable end portion is closer to the light incident end than the third optical element;
when viewed along a first axis, the movable end portion overlaps at least a portion of the second optical element; and
the first axis is perpendicular to the main axis.

4. The optical element driving mechanism as claimed in claim 3, wherein
the first optical module further includes a base, a second movable part and a third movable part;
the driving assembly is configured to drive the second movable part and the first movable part to move along the first axis relative to the third movable part;
the driving assembly is configured to drive the first movable part to move along a second axis relative to the second movable part and the third movable part;
the driving assembly is configured to drive the third movable part to drive the first movable part and the second movable part to move along the main axis;
the second axis is perpendicular to the first axis and the main axis;
the base has a first opening corresponding to the external light passing through the third optical element;
the base further has a first groove which is communicated with the first opening; and
a portion of the supporting base and the third optical element are located in the first groove.

5. The optical element driving mechanism as claimed in claim 4, wherein
the supporting base has a first supporting surface and a second supporting surface;
the base is disposed on the first supporting surface;
the second supporting surface corresponds to a light-emitting surface of the third optical element;
when viewed along the second axis, there is a first height between the first supporting surface and the second supporting surface along the main axis:
when viewed along the second axis, the first optical module has a second height; and
the first height is greater than one third of the second height.

6. The optical element driving mechanism as claimed in claim 5, wherein
when viewed along the main axis, at least a portion of the third movable part, the first movable part and the first optical element is exposed from the first groove;
when viewed along the main axis, the second movable part is shielded by the base;
the third movable part has a second opening, a third opening and a second groove;
the second opening is communicated with the first opening and the second groove, and the third opening is communicated with the second groove;
the second groove is located in the first groove;
the second groove and the first groove cooperatively accommodate a portion of the third optical element; and
at least a portion of the first movable part and at least a portion of the first optical element are exposed from the second groove.

7. The optical element driving mechanism as claimed in claim 6, wherein
the base has a first bottom surface and a first side inclined surface;
the first side inclined surface obliquely extends from the first bottom surface;
the third movable part has a second bottom surface and a second side inclined surface;
the second side inclined surface obliquely extends from the second bottom surface;
a gap is formed between the first bottom surface and the second bottom surface; and
the second side inclined surface is not aligned with the first side inclined surface.

8. The optical element driving mechanism as claimed in claim 7, wherein
when viewed along the first axis, the second side inclined surface is shielded by the base;
when viewed along the main axis, a portion of the second bottom surface is exposed from the first groove;
when viewed along the main axis, a size of the first groove is greater than a size of the second groove; and
when viewed along the main axis, the size of the first groove is greater than a size of the third opening.

9. The optical element driving mechanism as claimed in claim 8, wherein
the driving assembly includes a first coil and a first magnetic element configured to drive the second movable part and the first movable part to move along the first axis;
the driving assembly further includes a second coil and a second magnetic element configured to drive the first movable part to move along the second axis;
the driving assembly further includes a third coil and a third magnetic element configured to drive the third movable part, the second movable part and the first movable part to move along the main axis; and
when viewed along the first axis, the first coil overlaps at least a portion of the second optical element.

10. The optical element driving mechanism as claimed in claim 9, wherein
when viewed along the main axis, the base has a rectangular structure;
the first coil, the second coil and the third coil are respectively located on a first side, a second side and a third side of the rectangular structure;
the second optical element is located on a fourth side of the rectangular structure;
the first side and the fourth side are opposite sides of the rectangular structure; and
the second side and the third side are opposite sides of the rectangular structure.

11. The optical element driving mechanism as claimed in claim 10, wherein
the optical element driving mechanism further includes a second circuit assembly, which is disposed on the base and located on the first side, the second side and the third side;
the first optical module further includes a first supporting member, a second supporting member and a third supporting member, which are fixedly disposed on the second circuit assembly and respectively correspond to the first coil, the second coil and the third coil;
the first supporting member and the second supporting member are made of non-magnetically permeable metal material; and
the third supporting member is made of magnetically permeable metal material.

12. The optical element driving mechanism as claimed in claim 11, wherein
the first optical module further has two first perforations, penetrating the first supporting member and the second circuit assembly;
the two first perforations correspond to the first coil;
the first optical module further has two second perforations, penetrating the second supporting member and the second circuit assembly;
the two second perforations correspond to the second coil;
the first optical module further has two third perforations, penetrating the third supporting member and the second circuit assembly; and
the two third perforations correspond to the third coil.

13. The optical element driving mechanism as claimed in claim 10, wherein
the optical element driving mechanism further includes a first rolling element which is disposed between the first movable part and the third movable part;
the optical element driving mechanism further includes a plurality of second rolling elements which are disposed between the first movable part and the second movable part; and
the optical element driving mechanism further includes a plurality of third rolling elements which are disposed between the second movable part and the third movable part.

14. The optical element driving mechanism as claimed in claim 13, wherein
the second movable part has a base plate and a protruding portion;
the protruding portion protrudes from the base plate toward the first movable part;
when viewed along the first axis, the protruding portion overlaps at least a portion of the first movable part;
the first movable part has a first accommodation groove and a plurality of first slots;
the first accommodation groove is configured to accommodate the first rolling element; and
the first slots are configured to accommodate the second rolling elements.

15. The optical element driving mechanism as claimed in claim 14, wherein
the second movable part has a plurality of second slots configured to accommodate the second rolling elements;
an extending direction of the second slots is the same as an extending direction of the first slots;
the second movable part further has a plurality of third slots configured to accommodate the third rolling elements;
when viewed along the main axis, the second movable part has an L-shaped structure;
the third movable part has a second accommodation groove and a plurality of fourth slots;
the second accommodation groove is configured to accommodate the first rolling element;
the fourth slots are configured to accommodate the third rolling elements;
an extending direction of the fourth slots is the same as the extending direction of the third slots; and
the first magnetic element and the second magnetic element are fixedly disposed on the first movable part.

16. The optical element driving mechanism as claimed in claim 15, wherein
the first optical module further includes a first magnetic conductive element and a second magnetic conductive element, which are disposed on the third movable part;
the first magnetic conductive element and the second magnetic conductive element respectively correspond to the first magnetic element and the second magnetic element;
when viewed along the main axis, the first magnetic conductive element overlaps the first magnetic element; and
when viewed along the main axis, the second magnetic conductive element overlaps the second magnetic element.

17. The optical element driving mechanism as claimed in claim 5, wherein
the casing is made of non-magnetic material;
the casing covers at least a portion of the first optical element and the second optical element;
the casing has a first top wall, a second top wall and an inclined wall;
the inclined wall is connected between the first top wall and the second top wall;
an angle between the inclined wall and the second top wall is between 30 and 60 degrees; and
the second top wall forms the casing opening, and a portion of the second optical element is disposed in the casing opening.

18. The optical element driving mechanism as claimed in claim 17, wherein
the optical element driving mechanism further includes a second optical module, which is disposed on the second top wall and surrounds a portion of the second optical element;
when viewed along the main axis, the first optical element overlaps the first top wall;
when viewed along the main axis, the first top wall completely shields the first optical element;
along the main axis, there is a first distance between the first top wall and the second supporting surface;
along the main axis, there is a second distance between the second top wall and the second supporting surface; and
the first distance is greater than the second distance.

19. The optical element driving mechanism as claimed in claim 18, wherein
the optical element driving mechanism further includes a first electrical member, a second electrical member and a third electrical member, which are partially disposed in the supporting base;
the first circuit assembly further has a fixed end portion, which is affixed to the supporting base and is electrically connected to the first electrical member;
the second top wall of the casing is further formed with a side opening, which is arranged on one side of the casing opening;
the second electrical member is exposed from the side opening; and
the second optical module is electrically connected to the second electrical member through the side opening.

20. The optical element driving mechanism as claimed in claim 19, wherein
the optical element driving mechanism further includes a second circuit assembly, which is disposed on the first optical module and electrically connected to the driving assembly;
the second circuit assembly is electrically connected to the third electrical member;
the optical element driving mechanism further includes a plurality of electrical pins, which are partially disposed in the supporting base;
the first electrical member, the second electrical member and the third electrical member are electrically connected to an external circuit through the electrical pins;
when viewed along the main axis, the supporting base has a rectangular structure; and
the electrical pins are located on a long side of the rectangular structure.
